(19) United States
(12) Patent Application Publication
(10) Pub. No.: US 2026/0211841 A1
(43) Pub. Date: Jul. 23, 2026

(54) METHOD AND APPARATUS FOR TELEMETRY OF SYSTEM ON A WAFER

(71) Applicant: Tesla, Inc., Austin, TX (US)

(72) Inventors: Benjamin Floering, San Jose, CA (US); Kamran Hasan, Santa Cruz, CA (US); Adam Nasr, Palo Alto, CA (US)

(21) Appl. No.: 19/114,665

(22) PCT Filed: Sep. 28, 2023
(86) PCT No.: PCT/US2023/033939

§ 371 Date: Mar. 24, 2025

Related U.S. Application Data
(60) Provisional application No. 63/378,013, filed on Sep. 30, 2022.

(51) Int. Cl. G06F 15/80; G06F 11/34

(52) U.S. Cl. CPC G06F 15/80; G06F 11/3409

(57) ABSTRACT

The present disclosure relates to systems and methods for monitoring a computing resource of a computing system. The computing resource may include a plurality of system on wafers (SoWs) that each includes an array of dies. The monitoring is based on receiving telemetry data from a die included in a SoW of the computing resource. An example computing system includes a SoW, a microcontroller communicatively coupled with SoW and that receives telemetry data associated with at least one of the dies, and a controller configured to obtain data from the microcontroller, determine the performance of the die of the SoW, and in response to determining that the performance is degraded, apply a corrective action.

### CROSS-REFERENCE TO PRIORITY APPLICATION

This application claims the benefit of priority of U.S. Provisional Application No. 63/378,013, filed Sep. 30, 2022, and titled “METHOD AND APPARATUS FOR TELEMETRY DISPLAY OF SYSTEM ON A WAFER,” the disclosure of which is hereby incorporated by reference in its entirety and for all purposes.

### BACKGROUND

### Technical Field

This disclosure relates generally to an apparatus for collecting telemetry data from a system-on-a-wafer (SOW) and processing the collected telemetry data.

### Description of Related Technology

Certain computing systems can be used in and/or specifically configured for high performance computing and/or computationally intensive applications, such as neural network training, neural network inference, machine learning, artificial intelligence, complex simulations, or the like. In some applications, a computing system can be used to perform neural network training. For example, such neural network training can generate data for an autopilot system for vehicle (e.g., an automobile), other autonomous vehicle functionality, or Advanced Driving Assistance System (ADAS) functionality.

In high performance computing systems, there can be a high density of processing dies. It can be desirable to obtain telemetry data associated with the processing dies. In computing systems with a large number of processing dies, there are technical challenges associated with processing telemetry data.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a computing system that includes an array of dies included on a system on a wafer (SoW), a microcontroller configured to receive telemetry data associated with at least one die of the array of dies, and a controller configured to obtain data that comprises the telemetry data from the microcontroller, determine a performance metric of a particular die of the array of dies by processing the obtained data, and apply a corrective action in response to determining that the performance metric satisfies a threshold. The dies of the array are configured to output telemetry data.

In the computing system, the corrective action can include deactivating the particular die.

In the computing system, the corrective action can include throttling of the particular die.

In the computing system, the controller can be configured to identify the particular die that generated the telemetry data.

In the computing system, the microcontroller can be configured to provide the telemetry data to the controller with a first resolution in a first mode and a second resolution in a second mode.

In the computing system, the microcontroller can be configured to communicate with two dies of the array of dies.

In the computing system, the controller can be configured to receive data from a plurality of SoWs.

In the computing system, the telemetry data can include data associated with operating temperature, voltage, and current with the at least one die.

In the computing system, the controller can further be configured to generate a graphical representation of the processed data.

In the computing system, the controller can further be configured to aggregate the telemetry data for a post processing of the aggregated data.

In the computing system, the controller can be configured to partition the dies of the SoW to perform parallel tasks.

Another aspect of this disclosure is a method of monitoring a computing system. The method includes obtaining telemetry data from the computing system and determining a performance metric of individual dies of at least one a SoW of the plurality of SoWs by processing the obtained telemetry data. The computing system includes a plurality of system on wafers (SoWs). Additionally, each SoW of the plurality of SoWs includes an array of dies.

In the method, the method can further include applying a corrective action in response to determining that the performance metric of a particular die satisfies a threshold. The corrective action can include deactivating the particular die. Additionally, the corrective action can include throttling the particular die.

In the method, the method can also include toggling a mode of a microcontroller from a first mode to a second mode such that the microcontroller provides telemetry data associated with a particular die of a SoW of the plurality of a SoWs with a different resolution in the second mode than in the first mode.

In the method, the telemetry data can include at least one of operating temperature, voltage, current, and power consumption of the individual dies.

In the method, the method can further include generating a graphical representation of the performance metric for the individual dies.

Another aspect of this disclosure is a non-transitory computer-readable storage medium. The storage medium includes instructions that, when executed by one or more processors, cause to perform the method of monitoring a computing system. The method includes obtaining telemetry data from the computing system and determining a performance metric of individual dies of at least one SoW of the plurality of SoWs by processing the obtained telemetry data. The computing system includes a plurality of a system on wafers (SoWs). Additionally, each SoW of the plurality of SoWs includes an array of dies.

Another aspect of this disclosure is a method of providing a visualization of a performance metric of dies of a system on a wafer (SoW). The method includes obtaining telemetry data from dies of the SoW, wherein the SoW comprises an array of dies, determining the performance metric for each of the dies of the SoW based on processing the telemetry data, and providing a graphical representation of the performance metric of each of the dies of the SoW based on the determination.

Another aspect of this disclosure is a non-transitory computer-readable storage medium. The storage medium includes instructions that, when executed by one or more processors, cause to perform the method of obtaining telemetry data from dies of the SoW, determining the performance metric for each of the dies of the SoW based on processing the telemetry data, and providing a graphical representation of the performance metric of each of the dies of the SoW based on the determination. The SoW includes an array of dies.

Another aspect of this disclosure is a system that includes an array of dies on a system on a wafer (SoW), each die of the array configured to output telemetry data, and a microcontroller configured to receive telemetry data from at least two dies of the array of dies. The microcontroller is operable in at least a first mode and a second mode such that the microcontroller outputs the telemetry data with different resolutions in the first mode and the second mode.

In the system, the microcontroller can be configured to output the telemetry data with information identifying respective dies of the array of dies associated with portions of the telemetry data.

For purposes of summarizing the disclosure, certain aspects, advantages, and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will be described, by way of non-limiting examples, with reference to the accompanying drawings.

FIG. 1 illustrates an example of a cabinet that includes one or more processing systems according to embodiments disclosed herein.

FIG. 2 illustrates an example of a computing system according to the embodiments disclosed herein.

FIG. 3A illustrates an example SoW that includes an array of dies.

FIG. 3B illustrates an array of nodes included in each die.

FIG. 4 illustrates an example of interactions between a controller and SoW and die.

FIG. 5 illustrates an example of partitioning dies of the SoW.

FIG. 6A illustrates an example of a graphical representation of processed telemetry data at the SoW level according to embodiments disclosed herein.

FIG. 6B illustrates an example of a graphical representation of processed telemetry data at the die level, according to embodiments disclosed herein.

FIG. 7 illustrates an example of a controller.

FIG. 8A illustrates an example of interactions between a controller, a group of microcontrollers, SoWs, and dies, according to the embodiments disclosed herein.

FIG. 8B illustrates an example of interactions between dies and microcontrollers, according to the embodiments disclosed herein.

FIG. 8C illustrates an example of interactions between a microcontroller and two dies, according to the embodiments disclosed herein.

FIG. 8D illustrates an example of interactions between a microcontroller and a die, according to the embodiments disclosed herein.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals and/or terms can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

This disclosure relates to an apparatus that collects and displays data from a system-on-a-wafer (SoW) in real time and for playback. Telemetry data sent by a SoW can be configured for use in debugging and/or operational status. A method can include collecting and distributing high-volume telemetry to apparatus endpoints.

A SoW can include an array of integrated circuit dies packaged together with each other. The SoW can achieve a high compute density. The SoW can include an integrated cooling system. A system tray can include an array of SOWs supported by a common structure and connected to each other. System trays can be arranged within a computing cabinet. SoWs of adjacent computing cabinets can be connected to each other in a computing system.

As the demand for computing resources of a computing system increases, a high density computing system is desired. For example, the computing system can include one or more SoWs, and each SoW can include an array of integrated circuit dies. However, monitoring the operation (or performance) and operating environment of each die can be challenging. For example, the dies can generate heat during operation, and a portion of the SoW (e.g., group of dies in the SoW) can have a relatively higher temperature than other portions. In another example, one or more dies in the SoW can have a relatively lower power supply than other dies in the SoW. Thus, the performance of these dies with the lower power supply can have their performance degradation.

Traditionally, it has not been possible to detect integrated circuit dies that have a decreased performance due to the operation or operating environment of each die integrated into a SoW in real-time. This lack of real-time monitoring can lead to performance degradation of the SoW if one or more of its dies become inoperable or experiences decreased performance. Furthermore, if a portion of the SoW (e.g., group of dies in the SoW) has degraded performance, that could result in the entire SoW having degraded performance. This situation could lead to inefficient utilization of the computing resources within the computing system.

To address at least a portion of the above-described technical challenges, one or more aspects of the present disclosure correspond to a computing system that includes one or more SoWs and one or more controllers. Each SoW can be communicatively coupled with the controller and send data to the controller. The data can include telemetry data. The telemetry data can include information collected from each die or portion of a SoW (e.g., group of dies within the SoW). The telemetry data can include environmental information, such as but not limited to one or more of the surrounding and/or operating temperature of die(s), operational parameters, such as power supply to each die, current and/or voltage measurements for the die(s), and performance information, such as usage of die(s), bandwidth, or latency. Even though the present disclosure describes the telemetry data with a particular type of data, these descriptions are merely provided as examples, and the present disclosure does not limit the types of telemetry data.

Telemetry data can be sent from individual dies of a SoW to one or more microcontrollers on a control plane. As one example, a SoW can include 25 dies, and 13 microcontrollers can receive telemetry data from the individual dies. In this example, 12 microcontrollers can receive telemetry data from two dies of the SoW, and 1 microcontroller can receive telemetry data from 1 die of the SoW. The microcontrollers can provide telemetry data to a controller together with information identifying the individual dies associated with portions of the telemetry data. The controller can process and aggregate telemetry data from microcontrollers associated with the dies of one or more SoWs. The controller can generate one or more graphical representations based on the processed telemetry data. Alternatively or additionally, the controller can direct one or more corrective actions based on the processed telemetry data.

Although embodiments disclosed herein may relate to computing systems with SoWs, any suitable principles, and advantages disclosed herein can be applied to computing systems, including a plurality of dies that are partitioned to performing computing, tasks.

The computing system, as disclosed herein, can also be configured to collect the telemetry data and provide an interface for visualizing the collected telemetry data and/or one or more performance metrics derived from the collected telemetry data. More specifically, the computing system can include a controller, and the controller can collect the telemetry data. In some embodiments, the controller can collect the telemetry data from one or more SoWs, a plurality of SoWs, an individual die of a SoW, and/or one or more portions of the dies within the SoW. The controller can process the collected data and provide a graphical representation of the processed collected telemetry data. The graphical representation can provide various resolutions to depict both the SoW as a whole and its individual or portions of dies. For instance, the system's graphical interface can provide functionalities that allow users to examine the processed telemetry data at the SoW level and/or at the die level within each SoW.

The computing system, as disclosed herein, can control the operating parameters of each die, a portion of the SoW (e.g., group of dies in the SoW), and/or each SoW based on the processed results of collected telemetry data. For example, the computing system may apply one or more corrective instructions based on the processed results of the collected telemetry data. For example, the system may control the supply power of die(s) within the SoW based on the processed results of the collected telemetry data. As another example, the system can throttle one or more dies of the SoW based on the processed results of the collected telemetry data.

The principles and advantages disclosed herein can be applied to any suitable computing system. In certain applications, the disclosed system can be applied to SoWs, each of which includes an array of smaller dies. The system can monitor the operation and operational environment of the die by receiving telemetry data from each die. The system can also provide a visual representation of the processed telemetry data in different resolutions, such as in each die level or SoW level. Thus, a user or operator can identify the operation of each die and its environment in real-time. Furthermore, the system may automatically implement one or more corrective measures upon identifying an issue in the operation or operational environment of the die. As a result, this disclosed system can enhance the efficiency within a computing system.

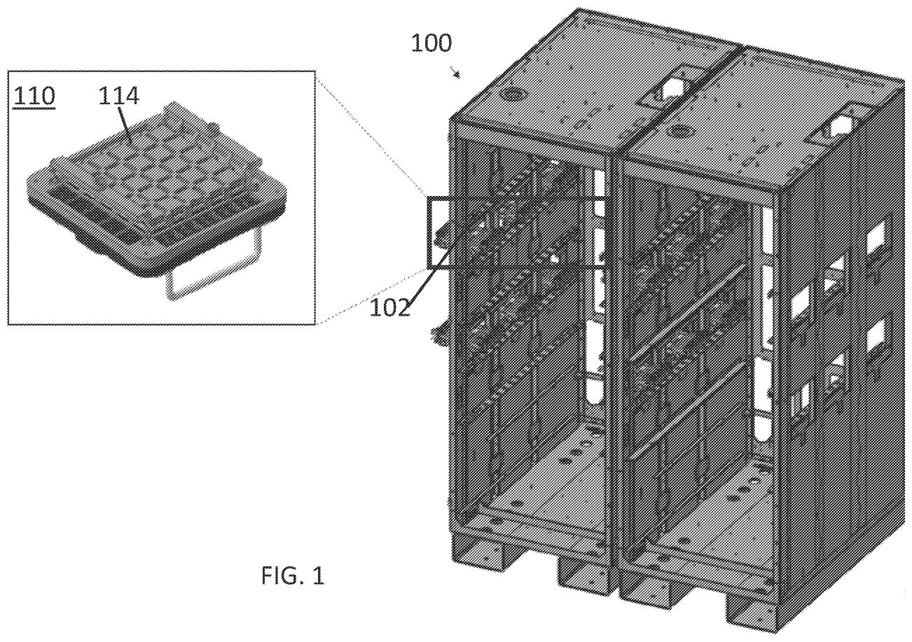

In some aspects of the present disclosure, a plurality of SoWs are utilized as computing resources of a computing system. For example, FIG. 1 illustrates an example of two cabinets 100 that can include a plurality of computing tiles 110. As shown in FIG. 1, the cabinet 100 can include one or more sockets 102 or guide rails, and a system tray that includes an array of computing tiles 110 can be inserted into the cabinet 100 via the socket 102. Each cabinet 100 of FIG. 1 includes a cabinet structure arranged to receive two system trays, where each system tray includes an array of computing tiles 110 (for example, a 2×3 array of computing tiles 110). Thus, multiple computing tiles 110 can be integrated into the cabinet 100, and the present disclosure does not limit the types of sockets and number of sockets, and these types and numbers can be determined based on specific applications.

In some embodiments, the computing tile 110 can include one or more of control board structures, cooling systems, voltage regulator modules, a frame structure, a SoW, and a heat dissipation structure. An example of the computing tile 110 is disclosed in International PCT Application No. PCT/US2022/040420, titled “CONNECTOR SYSTEM FOR CONNECTING PROCESSOR SYSTEMS AND RELATED METHODS,” the disclosure which is hereby incorporated by reference herein in its entirety. In certain applications, a SoW of the computing tile 110 includes microcontrollers that obtain telemetry data from the dies of the SoW. In various applications, the computing tile 110 can include a circuit board that includes a plurality of microcontrollers thereon that obtain telemetry data from dies of the SoW of the computing tile 110. According to some other applications, microcontrollers external to the computing tile 110 that are on a circuit board on a system tray can obtain telemetry data from the dies of the SoW.

A plurality of SoWs can be implemented within a cabinet, and the present disclosure provides systems and methods for monitoring the operation (and/or operating environments) of each SoW and its dies, generating a graphical representation of the monitored results and controlling operation of each SoW and its dies based at least on the monitored results.

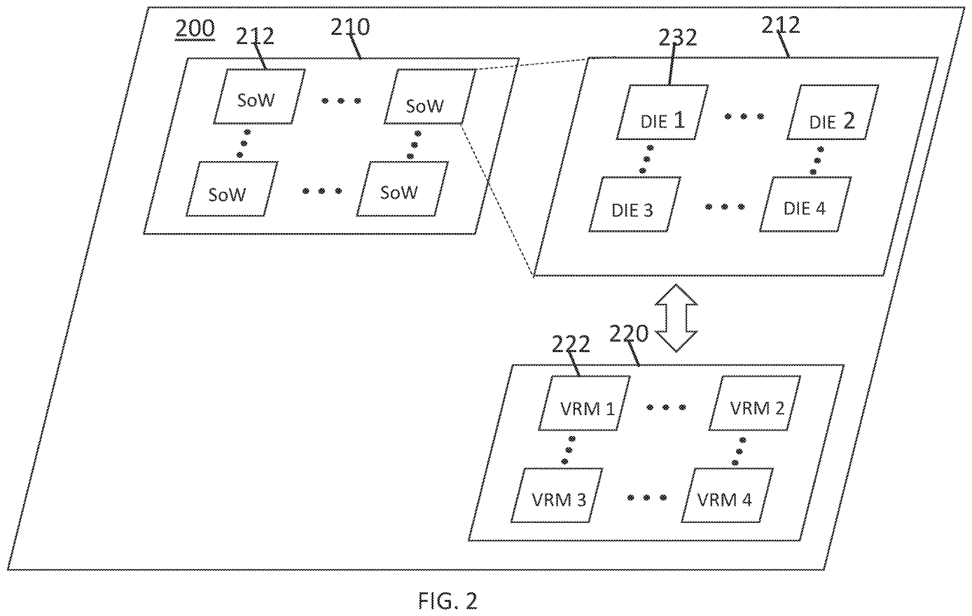

FIG. 2 illustrates an example computing system 200. As shown in FIG. 2, the computing system 200 can include a SoW array 210. Each SoW 212 of the SoW array 210 can correspond to a computing tile 110 (shown in FIG. 1). The SoW array 210 can include SoWs 212 on one or more system trays and/or within one or more cabinets. The SoW array 210 can be utilized as computing resources of the computing system 200. The number of SoWs 212 of the SoW array 210 can be determined based on specific applications.

Each SoW 212, as shown in FIG. 2 can include an array of dies 232, for example, as further illustrated in FIG. 2. Any suitable number of dies 232 can be included in the SoW 212.

As further illustrated in FIG. 2, the computing system 200 can include an electronic module array 220. In some embodiments, the electronic modules are voltage regulating modules (VRMs) 222. The dies 232 can be interconnected with the electronic module array 220. In some embodiments, the array of dies 232 and the electronic module array 220 are stacked vertically. A computing tile 110 of FIG. 1 can include a SoW 212 stacked with an electronic module array 220 of VRMs 222. Each VRM 222 can be connected to and provide power to its corresponding die 232. For example, dies 1, 2, 3, and 4 can be connected to each corresponding VRM 1, 2, 3, and 4, respectively. Each VRM 222 can be configured to supply an input power (e.g., input voltage) to the corresponding die 232. For example, each VRM 222 can receive a direct current (DC) supply voltage from an external power supply source (not shown in FIG. 2) and generate an output voltage to supply to the corresponding die 232.

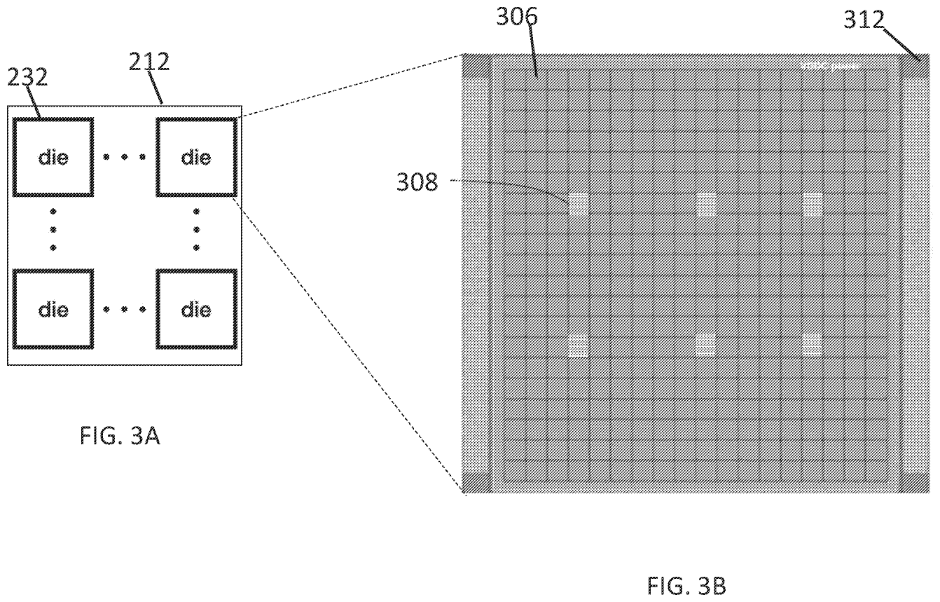

FIG. 3A illustrates an example of SoW 212 that includes an array of dies 232. The die 232 can be an integrated circuit die. The dies 232 can be implemented on the SoW 212 that is packaged with a wafer-level packaging structure.

As shown in FIG. 3B, in some embodiments, the die 232 can include an array of nodes. The array of nodes can include compute nodes 306 and global nodes 308. In some embodiments, the compute nodes 306 can include circuitry for performing processing tasks. The global nodes 308 can generate telemetry data for the die 232. The global nodes 308 may not include circuitry for performing processing tasks. For example, the global nodes 308 may include pressure, voltage, and temperature (PVT) sensors to monitor the operating conditions of the die 232. In some implementations, compute nodes 306 and global nodes 308 may both include communication interfaces to enable communication with neighboring nodes. For example, each global node 308 can monitor the operating voltage of the surrounding nodes by receiving the current supply voltage from the neighboring nodes via the communication interfaces. In some implementations, the communication interfaces for compute nodes 306 may be the same as the communication interfaces for global nodes 308.

In some embodiments, each die 232 can generate telemetry data. The telemetry data can refer to information generated from each die. The information can include, but is not limited to, one or more environmental information, such as surrounding and/or operating temperature of die(s), operational parameters, such as power supply to each die, current and/or voltage measurements for the die(s), and performance information, such as usage of die(s), bandwidth, and/or latency. For example, each die 232 can be configured to communicate data with the SoW 212 via the input/output interface 312. In this example, the global nodes 308 can be configured to provide its data to the SoW 212 via the interface 312. In some scenarios, the global nodes 308 may continuously monitor the operation parameters of the compute node 306 by enabling the communication interfaces with the neighboring compute nodes 306. Furthermore, the global nodes 308 may continuously measure the operating temperature of the die 232.

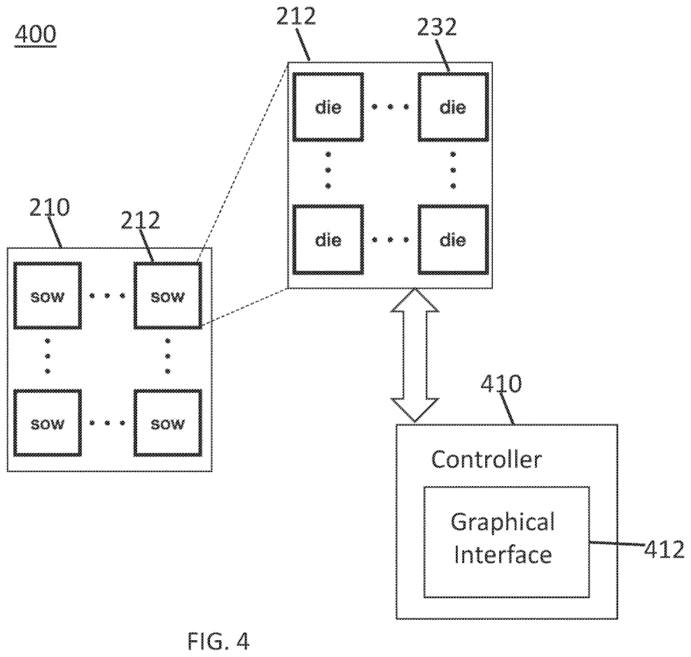

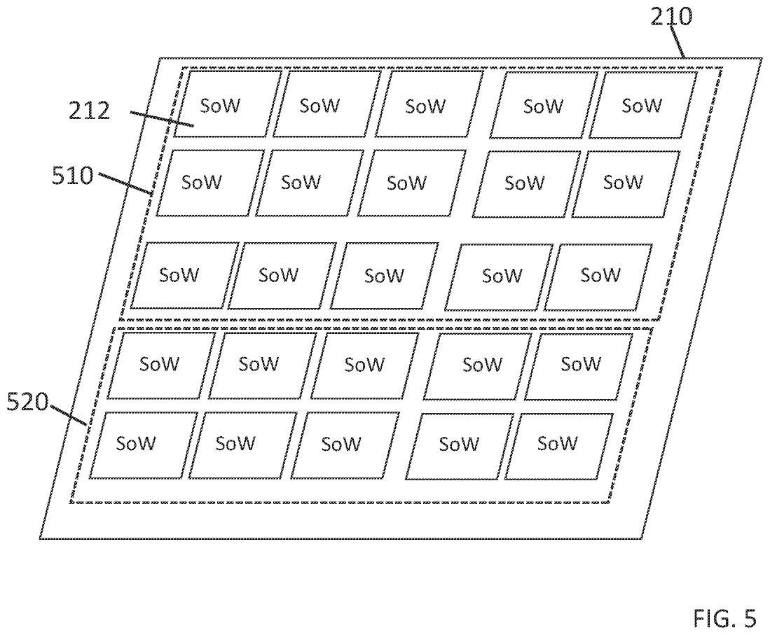

FIG. 4 illustrates an example of computing system 400 according to one or more embodiments as disclosed herein. As illustrated in FIG. 4, the computing system 400 can include SoW array 210 and a controller 410. Each SoW 212 of the SoW array 210 can include an array of dies 232, and each die can include an array of compute node 306, for example, as described in FIGS. 3A and 3B. The controller 410 can include a microcontroller or a computing device that can perform computing processes, and the present disclosure does not limit the types of the controller 410. In addition, one or more controllers 410 can be implemented to perform one or more embodiments as disclosed herein.

In some embodiments, the controller 410 can be configured to partition the SoW array 210 into one or more partitions. For example, the controller 410 can partition the SoWs 212 of the SoW array 210 into two partitions, and each partition can be utilized as a computing resource for a specific computing task. The controller 410 can also partition the SoW array 210 based on computing resources specified for each task. For example, if there are two tasks, task A and B, where task A involves more computing resources, then the controller 410 may partition the SoW array 210 into two partitions, each containing a different number of SoW 212. In this example, the partition with the higher number of SoW 212 can be used to perform the task A.

FIG. 5 illustrates an example of the partitions of an SOW array 210. As illustrated in FIG. 5, the SoW 212 in the SoW array 210 is partitioned into two partitions, partition 510 and partition 520. In FIG. 5, the partition 520 can include more SoWs 212 than the partition 510. Thus, the partition 520 can provide more computing resources than the partition 510. In some embodiments, the controller 410 can estimate the number of tasks and required computing resources to perform each task. Then, the controller 410 can partition the SoW array 210 and assign the partitions based on the required computing resources for each task. Even though FIG. 5 describes the certain number of SoW 212 and two partitions, these are merely provided as an example, and the present disclosure does not limit the number of dies and partitions. In addition, the number of dies and partitions can be determined based on specific applications.

As illustrated in FIG. 4, the controller 410 can be configured to exchange data with the dies 232 of the SoW 212. In some embodiments, each die 232 may send telemetry data to the controller 410. For example, the global node 308 (shown in FIG. 3B) may collect the telemetry data and transmit the telemetry data to the controller 410. The controller 410 is capable of receiving telemetry data from multiple dies 232. In some instances, the controller 410 can simultaneously receive telemetry data from a plurality of dies 232.

In a computing system with an array of SoWs 210, a large volume of telemetry data can be generated. Processing and organizing such telemetry data present technical challenges.

In certain embodiments, the controller 410 can identify each die and store the telemetry data by linking the received data with a specific die 232 that transmits the telemetry data. For instance, the controller 410 can store a unique address associated with each die 232 and its SoW 212. Moreover, each die 232 can transmit its own identifier when sending the telemetry data in certain applications. This can enable the controller 410 to match the telemetry data with the corresponding die that generated the telemetry data. In some embodiments, each die 232 can transmit its telemetry data periodically. In these embodiments, the period can be provided by a system operator of the computing system 400. In some other embodiments, the period can be determined based on the clock frequency of the die.

The controller 410 is capable of real-time monitoring and processing of the received telemetry data. In certain applications, the controller 410 can filter the received data based on one or more metrics. For instance, the controller 410 can employ a metric like temperature. In this case, the controller 410 could process the telemetry data in relation to each die's operating temperature and filter out the dies based on this temperature, such as excluding those dies operating above a specified threshold temperature.

In some embodiments, the controller 410 can process the received telemetry data from each die at varying resolutions. For example, the controller 410 may process the telemetry data received from a first die with higher resolution than the telemetry data received from the second die. The controller 410 can process the telemetry data with different resolutions in different modes.

In various embodiments, the controller 410 can apply one or more corrective actions based on the processing results of the received telemetry data from the dies 232. The corrective actions can include but are not limited to performing throttling, deactivating die(s), reinitiating die(s), controlling supply power, and the like. In some embodiments, the controller 410 can utilize one or more mathematical operations when applying the corrective actions. For example, when the telemetry data is transmitted from a specific die, the controller 410 may add current data and temperature data from the received telemetry data. Then, the controller 410 may determine one or more corrective actions, such as throttling and controlling power supplied to the die.

In certain scenarios, the controller 410 can reconfigure the partitioning of the dies based on the results from monitoring the telemetry data received from the dies 232. For instance, if the controller 410 initially partitioned the dies into two segments, with the first segment containing more dies than the second, it may re-partition the dies 232 if it determines to deactivate one or more dies due to overheating.

The controller 410 can be configured to communicate with a SoW 212. In some embodiments, the controller 410 can store the telemetry data by categorizing the data based on the identification of SoW 212 and dies 232. For example, each die 232 can have an identifier that indicates the SoW 212 that the die belongs to as well as the die's specific identification within that SoW. The identifier can be composed of specific protocols, such as internet protocol or the like. The present disclosure does not limit the types of identification or its protocol. In some embodiments, the controller 410 can aggregate the telemetry data from a plurality of dies 232 and/or a plurality of SoWs 212.

In various embodiments, the controller 410 can perform a post processing of the aggregated telemetry data for each die. In some embodiments, the controller 410 can determine the correlation between the telemetry data and the performance of each die. For example, by analyzing the aggregated data, the controller 410 may identify a threshold operating temperature of the die that can cause computing degradation. In these embodiments, the controller 410 can be configured to automatically apply one or more corrective actions in response to detecting that the operating temperature of the die satisfies a threshold. In another instance, the controller 410 can establish a correlation between the operating time of the die and its operating temperature. In this scenario, the controller 410 can automatically apply one or more corrective actions at specific operating times of the die that correspond to a predefined threshold temperature.

In some embodiments, the controller 410 can perform post-processing to determine the external operating environment of the computing system 400. This can involve processing aggregated telemetry data correlated with one or more external factors, such as the power supply to each die, the die's cooling structure, and so on. Such analysis can help optimize the environment for operating the computing system 400. For instance, if the computing system 400 is housed in cabinet 100 of FIG. 1 within a data center, the results of post-processing can provide information about the data center's ambient temperature, the level of power supplied to the computing system, and other relevant factors.

The controller 410 can also include a graphical interface 412. The graphical interface 412 can generate a graphical representation of a performance metric. In certain embodiments, the graphical interface 412 may produce the graphical representation at two different resolutions, such as at a SoW level and a die level.

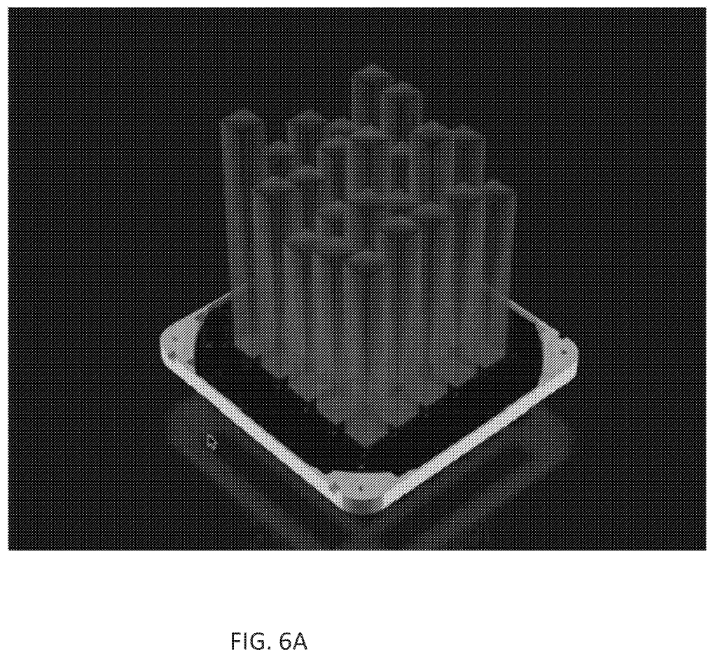

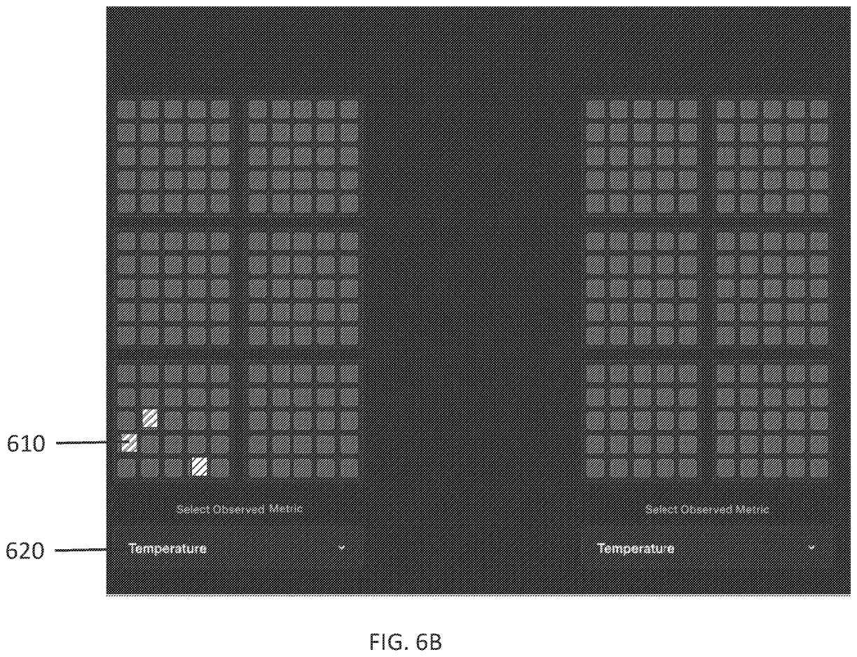

FIG. 6A shows an example graphical representation of a performance metric of a SoW with die level resolution. As shown in FIG. 6A, a temperature attribute of each die of the SoW can be indicated by varying levels of a square bar. The graphical representation of FIG. 6A can be useful in debugging and/or for enhancing the performance of a computing system.

FIG. 6B shows another graphical representation of a performance metric for SoWs of a computing system with die level resolution. In FIG. 6B, a temperature attribute of each die can be represented with different patterns (e.g., pattern 610), such that the dies depicted with the pattern have a higher operating temperature than the die without the pattern. Accordingly, a graphical representation of a performance metric for dies of a plurality of SoWs can summarize a large amount of performance data for the dies. Each graphical representation in FIG. 6B can include data associated with a performance metric for each die of 6 SoWs. In this example, each SoW includes 25 dies. The 6 SoWs can be included on a single system tray. Accordingly, the graphical interface of FIG. 6B can indicate a performance metric for each die of each SoW on a system tray.

As shown in FIG. 6B, a selection element 620 can be used to select from a plurality of performance metrics to be displayed on the graphical interface. As illustrated, temperature is the selected performance metric. The selection element 620 can be used to select another performance metric, such as voltage, and then the graphical interface can display voltage data for each die.

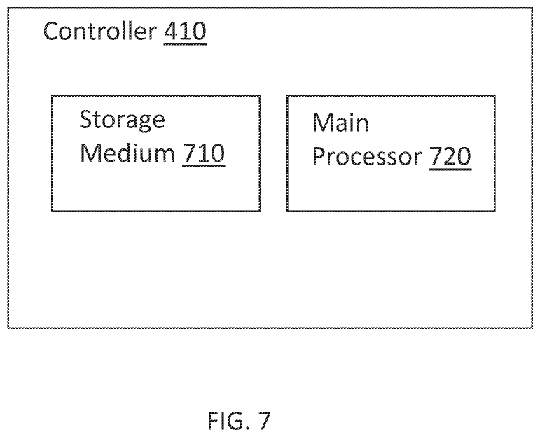

FIG. 7 illustrates an example of the controller 410. In some embodiments, the controller 410 can include at least the storage medium 710 and a main processor 720. The storage medium 710 is a non-transitory storage medium. In certain applications, the storage medium 710 is a non-volatile storage medium. The storage medium 710 can contain various instructions to execute one or more embodiments, as disclosed herein. It can also store and aggregate the telemetry data received from the dies 232. The main processor 720 can be used to execute the instructions stored within the storage medium 710. Furthermore, the main processor 720 can leverage its computing resources to process the received telemetry data and generate a graphical representation of the attributes of the processed telemetry data.

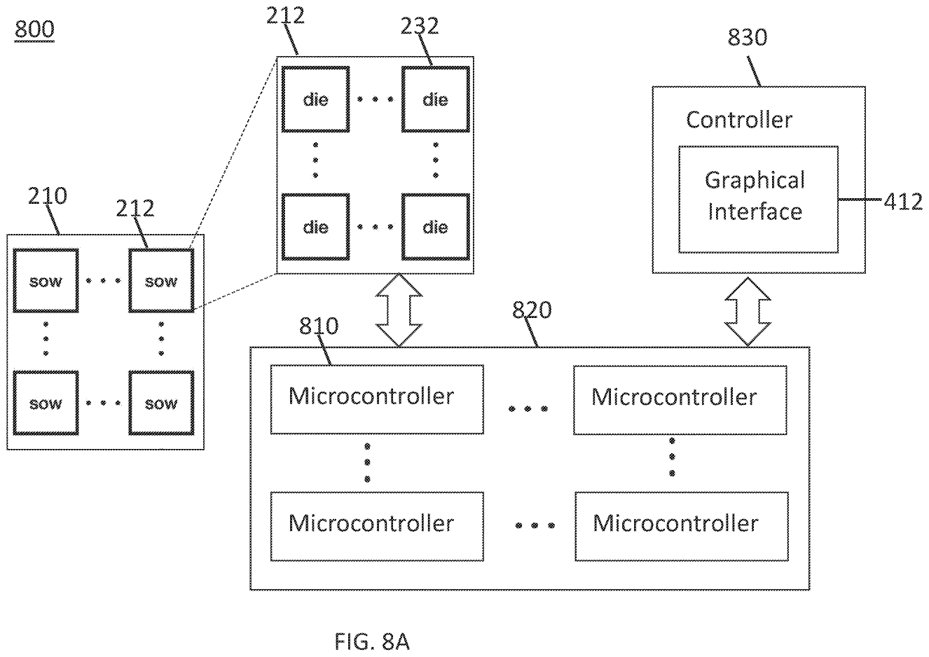

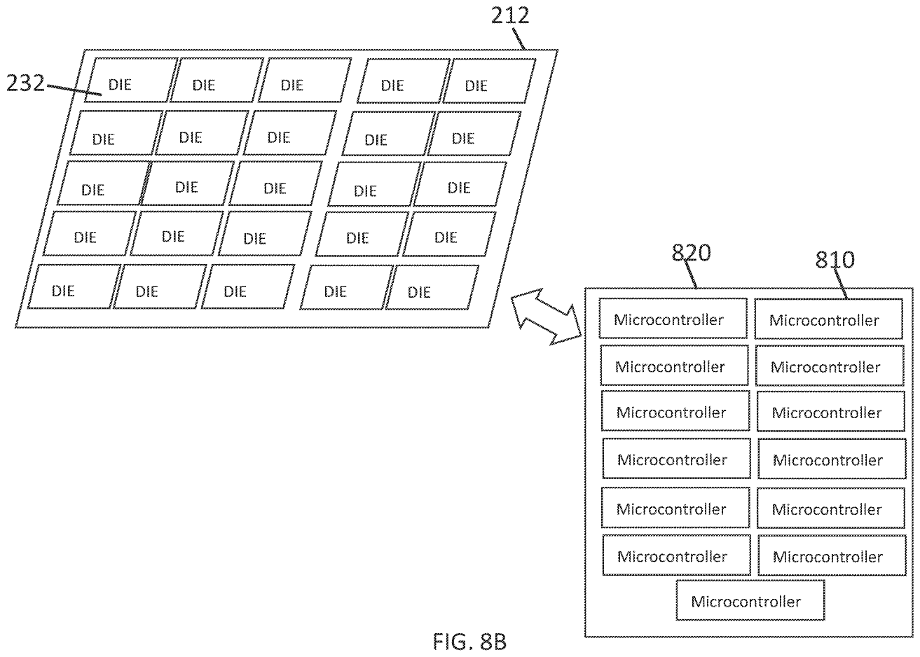

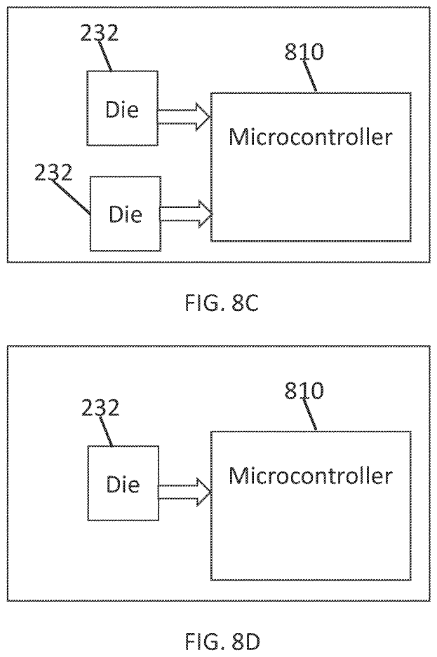

FIG. 8A illustrates an example of the computing system 800 according to one or more embodiments as disclosed herein. The computing system 800 can include SoW array 210 and a group of microcontrollers 820. In some embodiments, each microcontroller 810 can be configured to receive and process the telemetry data from one or more dies 232. For example, FIG. 8B illustrates an example of the group of microcontrollers 820 configurations. As shown in FIG. 8B, the SoW 212 includes 25 dies 232, and the group of microcontrollers 820 includes 13 microcontrollers 810. In this example, each of the 12 microcontrollers 820 can receive the telemetry data from 2 dies 232 (as shown in FIG. 8C), and I remaining microcontroller 820 can receive from the 1 remaining die 232 (as shown in FIG. 8D). This configuration is merely provided as examples, and the present disclosure does not limit the configurations. In some embodiments, a SoW can include both microcontrollers and dies that provide telemetry data to the microcontrollers. The group of microcontrollers 820 can be integrated into the computing tile 110 (shown in FIG. 1) or integrated as an external device.

As illustrated in FIG. 8A, each SoW 212 of the SoW array 210 can include an array of dies 232, and each die can include an array of compute nodes 306, as described in FIGS. 3A and 3B.

As further illustrated in FIG. 8A, each microcontroller 810 can be configured to communicate data with the dies 232. In some embodiments, each die 232 may send the telemetry data to the microcontroller 810. For example, the global node 308 (shown in FIG. 3B) may generate the telemetry data and transmit the telemetry data to the microcontroller 810. In some embodiments, the microcontroller 810 can receive telemetry data from one or more dies 232, such as illustrated in FIGS. 8C and 8D. For example, the group of microcontrollers 820 can include 13 microcontrollers 810. In this example, 12 microcontrollers can receive the telemetry data from 2 dies 232, such that each microcontroller receives the telemetry data from 2 dies 232, as shown in FIG. SC. Then, the remaining microcontroller 810 receives the telemetry data from the remaining die 232, as illustrated in FIG. 8D.

In some embodiments, each microcontroller 810 can request particular types of telemetry data from the one or more dies 232. In certain applications, the microcontroller 810 can dynamically select telemetry data associated with one or more particular metrics to obtain from the die 232. The microcontroller 810 can also control the resolution of the telemetry data and/or frequency at which the telemetry data is obtained. The microcontroller 810 can process telemetry data received from the die 232 by one or more of transforming, filtering, discarding, applying mathematical operations, or the like.

In certain embodiments, the microcontroller 810 can identify the die associated with the telemetry data and store the telemetry data by linking the received data with the specific die 232 that transmitted the telemetry data. For instance, the microcontroller 810 can store a unique address or identifier associated with each die 232. Moreover, each die 232 can transmit its own identifier when sending the telemetry data. This can enable the microcontroller 810 to match the telemetry data with the corresponding die that generated the telemetry data. In some embodiments, each die 232 can transmit its telemetry data periodically. In some of these embodiments, the period can be provided by a system operator of the computing system 800. Alternatively or additionally, the period can be determined based on the clock frequency of the die.

In some embodiments, the microcontroller 810 is operable in a plurality of modes that are associated with different resolutions of telemetry data. This can customize the resolution of the telemetry data. When more precise telemetry data is desired related to a particular performance metric, higher resolution telemetry data associated with the particular performance metric can be obtained and/or processed by the microcontroller. When telemetry data associated with a larger number of performance metrics is desired, lower resolution telemetry data associated with these particular performance metrics can be obtained and/or processed by the microcontroller. The microcontroller 810 can operate in a first mode with lower resolution telemetry data associated with more performance metrics. The microcontroller 820 can operate in a second mode with higher resolution telemetry data associated with fewer performance metrics. Accordingly, setting the mode of the microcontroller 810 can control the resolution of the telemetry data. In certain applications, one or more microcontrollers 810 can process telemetry data from different dies at different resolutions. For example, the microcontroller 810 may process the telemetry data received from a first die with higher resolution than the telemetry data received from the second die.

As further illustrated in FIG. 8A, the computing system 800 can also include a controller 830. The controller 830 can be any suitable controller in communication with the microcontrollers 810. In some instances, the controller 830 can be implemented in a cabinet (e.g., the cabinet 100 of FIG. 1). The controller 820 can be external to cabinets of a computing system in some applications. The controller 830 can exchange data with the microcontroller 810. In some embodiments, the controller 830 can be configured to partition the SoW array 210, as described in FIG. 5. For example, the controller 830 can partition the SoW array 210 into a plurality of partitions, and each partition can be utilized as a computing resource for a specific task.

In some embodiments, the controller 830 can receive the telemetry data for each die from each microcontroller 810 and also process the received telemetry data. For example, the controller 830 can process telemetry data received from the microcontroller 810 by one or more of transforming, filtering, discarding, applying mathematical operations, or the like.

The controller 830 can apply one or more corrective actions upon determining that the performance of the die is degraded based on the processing results of the received telemetry data. For example, the controller 830 may include thresholds that correspond to the performance metric of a particular die of the array of dies. In this example, if the telemetry data received from the die indicates that the performance metric meets the threshold, it can be determined that the performance of the die is degraded. A corrective action can be applied in response to determining that a performance metric associated with a particular die satisfies a threshold. The corrective actions can include but are not limited to performing throttling, deactivating die(s), reinitiating die(s), controlling supply power (e.g., adjusting parameters of a VRM), and the like. In some embodiments, the controller 820 can utilize a mathematical and/or logical operation when applying the corrective actions. For example, when the telemetry data is transmitted from a specific die, the controller 830 may add current data and temperature data from the received telemetry data. Then, the controller 830 may determine one or more corrective actions, such as throttling and/or reducing power supplied to the die.

The controller 830 can also augment the telemetry data with more information, such as identifying the partition of the SoW 312 that includes the die 232 associated with the received telemetry data. Telemetry data can be aggregated for the partition and then an action can be applied at the partition level. For example, a partition can be throttled to give more power to one or more other partitions. The controller 830 can receive one or more signals from other hardware in a data center, like power substations and cooling infrastructure. This can enable advanced data center analysis and correlation with the performance of one or more SoWs.

Data associated with telemetry and/or performance can be stored by the controller 830. The data can later be accessed for a variety of purposes, including but not limited to debugging and failure analysis.

The controller 830 can use telemetry data and other system information to implement power and/or thermal aware scheduling algorithms for computing resources that can enhance hardware utilization and/or build safety monitoring and altering control loops.

In certain scenarios, the controller 820 can reconfigure the partitioning of the dies based on the results from monitoring the telemetry data received from the dies 232. For instance, if the controller 820 initially partitioned the dies into two partitions, with the first partition containing more dies than the second, it may re-partition the dies 232 if it determines that one or more dies were deactivated due to overheating.

The controller 820 can also be configured to communicate with SoW 212. In some embodiments, the controller 820 can store the telemetry data by categorizing the data based on the identification of particular dies 232 associated with portions of the telemetry data. For example, each die 232 can have an index and the microcontroller 810 can have an address. In this example, the controller 820 can identify a particular die 232 associated with certain telemetry data based on the index of the die 232 and the address of the associated microcontroller 810. The identification can be performed in specific protocols, such as Internet protocol and the like. The present disclosure does not limit the types of identification and its protocol. In some embodiments, the controller 820 can aggregate the telemetry data.

In various embodiments, the controller 820 can perform a post processing of the aggregated telemetry data for each die. In some embodiments, the controller 820 can determine the correlation between the telemetry data and the performance of each die. For example, by analyzing the aggregated data, the controller 820 may identify a threshold operating temperature of the die that can cause computing degradation. In these embodiments, the controller 820 can be configured to automatically apply one or more corrective actions upon detecting that the operating temperature of the die is at or near the threshold temperature. In another instance, the controller 820 can establish a correlation between the operating time of the die and its operating temperature. In this scenario, the controller 820 can automatically apply corrective actions at specific operating times of the die that correspond to a predefined threshold temperature.

In some embodiments, the controller 820 can perform post-processing to ascertain the external operating environment of the computing system 800. This can involve processing aggregated telemetry data correlated with one or more external factors, such as but not limited to the power supply to each die, the die's cooling structure, and so on. Such analysis can help optimize the environment for operating the computing system 800. For instance, if the computing system 800 is housed in cabinet 100 (as depicted in FIG. 1) within a data center, the results of post-processing can provide information about the data center's ambient temperature, the level of power supplied to the computing system, and other relevant factors, The controller 820, as depicted in FIG. 8A, can also include a graphical interface 412. This interface 412 can be configured to generate a graphical representation of an attribute of the telemetry data. In certain embodiments, the graphical interface 412 may produce the graphical representation at two different resolutions, such as at a SoW level and a die level.

The computing system disclosed herein can be implemented in a variety of processing systems. Such processing systems can used in and/or specifically configured for high performance computing and/or computationally intensive applications, such as neural network training, neural network inference, machine learning, artificial intelligence, complex simulations, or the like. In some applications, the processing system can be used to perform neural network training. For example, such neural network training can generate data for an autopilot system for vehicle (e.g., an automobile), other autonomous vehicle functionality, or Advanced Driving Assistance System (ADAS) functionality.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

The foregoing description has been described with reference to specific embodiments. However, the illustrative discussions above are not intended to be exhaustive or to limit the inventions to the precise forms described. Many modifications and variations are possible in view of the above teachings. Others skilled in the art are thereby enabled to best utilize the techniques and various embodiments with various modifications as suited to various uses.

Although the disclosure and examples have been described with reference to the accompanying drawings, various changes and modifications will become apparent to those skilled in the art. Such changes and modifications are to be understood as being included within the scope of the disclosure.

1. A computing system comprising:
an array of dies included on a system on a wafer (SoW), wherein the dies of the array are configured to output telemetry data;
a microcontroller configured to receive telemetry data associated with at least one die of the array of dies; and
a controller configured to obtain data that comprises the telemetry data from the microcontroller, determine a performance metric of a particular die of the array of dies by processing the obtained data, and apply a corrective action in response to determining that the performance metric satisfies a threshold.

2. The system of claim 1, wherein the corrective action comprises deactivating the particular die.

3. The system of claim 1, wherein the corrective action comprises throttling of the particular die.

4. The system of claim 1, wherein the controller is configured to identify the particular die that generated the telemetry data.

5. The system of claim 1, wherein the microcontroller is configured to provide the telemetry data to the controller with a first resolution in a first mode and a second resolution in a second mode.

6. The system of claim 1, wherein the microcontroller is configured to communicate with two dies of the array of dies.

7. The system of claim 1, wherein the controller is configured to receive data from a plurality of SoWs.

8. The system of claim 1, wherein the telemetry data comprises data associated with operating temperature, voltage, and current with the at least one die.

9. The system of claim 1, wherein the controller is further configured to generate a graphical representation of the processed data.

10. The system of claim 1, wherein the controller is further configured to aggregate the telemetry data for a post processing of the aggregated data.

11. The system of claim 1, wherein the controller is configured to partition the dies of the SoW to perform parallel tasks.

12. A method of monitoring a computing system, the method comprising:
obtaining telemetry data from the computing system, wherein the computing system comprises a plurality of system on a wafers (SoWs), and wherein each SoW of the plurality of SoWs comprises an array of dies; and
determining a performance metric of individual dies of at least one SoW of the plurality of SoWs by processing the obtained telemetry data.

13. The method of claim 12, further comprising applying a corrective action in response to determining that the performance metric of a particular die satisfies a threshold.

14. The method of claim 13, wherein the corrective action comprises deactivating the particular die.

15. The method of claim 13, wherein the corrective action comprises throttling the particular die.

16. The method of claim 12, further comprising toggling a mode of a microcontroller from a first mode to a second mode such that the microcontroller provides telemetry data associated with a particular die of a SoW of the plurality of SoWs with a different resolution in the second mode than in the first mode.

17. The method of claim 12, wherein the telemetry data includes at least one of operating temperature, voltage, current, and power consumption of the individual dies.

18. The method of claim 12, further comprising generating a graphical representation of the performance metric for the individual dies.

19. Non-transitory computer-readable storage medium comprising instructions that, when executed by one or more processors, cause the method of claim 12 to be performed.

20. A method of providing a visualization of a performance metric of dies of a system on a wafer (SoW), the method comprising:
obtaining telemetry data from dies of the SoW, wherein the SoW comprises an array of dies;
determining the performance metric for each of the dies of the SoW based on processing the telemetry data; and
providing a graphical representation of the performance metric of each of the dies of the SoW based on the determined performance metric.

21. (canceled)

22. (canceled)

23. (canceled)
